(19) United States
(12) Patent Application Publication
(10) Pub. No.: US 2011/0228366 A1
(43) Pub. Date: Sep. 22, 2011

(54) HOE OPTICAL SYSTEM FOR HOLOGRAPHIC SIGHT

(75) Inventor: Shou LIU, Fujian Province (CN)

(73) Assignees: Shou LIU, Fujian Province (CN); KINGWORLD TECHNOLOGIES LIMITED, North Point (HK)

(21) Appl. No.: 12/728,485

(22) Filed: Mar. 22, 2010

(51) Int. Cl. G02B 5/32

(52) U.S. Cl. 359/15

(57) ABSTRACT

An optical system for holographic sights includes a laser diode, two mirrors, a holographic optical element (HOE) and a hologram. The two mirrors direct the diverging laser beam through a folded path to reach certain cross sectional area. The HOE filters, collimates and deflects the beam. Under the illumination of a collimated beam, the hologram projects a virtual reticle image at target plane. The HOE and the hologram are mounted in parallel and have the same period to achieve diffraction match so as to eliminate the image shift.

### BACKGROUND OF THE INVENTION

Holographic sights have been developed quickly since late 1990s. The special characteristics of holographic sights, such as fast and accurate aiming, good concealment of the user, effective functioning even when the hologram in the system is contaminated or broken, have attracted great attentions of weapon specialists and researchers. Holographic sights have been successfully applied in real combats.

The basic principle of holographic sights is to use a visible laser beam emitted from a laser diode (LD) as the light source. The laser beam is directed by several optical elements, and then illuminates a hologram. The optical elements from LD to hologram form an optical system. Under the illumination of the laser beam, the hologram generates a clear holographic virtual image (usually a reticle image) in the horizontal direction in front of the hologram. Through the hologram the shooter can see the reticle image on the target plane thus can fire immediately, which greatly simplifies the aiming process and increases the shooting speed. Therefore holographic sights are especially suited for close combats.

Since hologram is a diffractive element, the position of the holographic image varies with laser wavelength. When the wavelength of the laser beam emitted by LD drifts due to temperature change, the image position will change accordingly, this greatly affects aiming accuracy.

It is clear from the above description that the key technique in designing a holographic sight is to realize an optical system that can collimate and filter a laser beam, can generate a clear and parallax-free holographic virtual reticle image, and can eliminate the displacement of the image in spite of the wavelength drift, so as to guarantee accurate aiming. So far, several patents concerning the optical systems of holographic sights have been issued. However, they all have drawbacks.

Patent CN200420074252.0 discloses a simple optical system for a holographic sight. In the optical system the laser beam is not filtered so that the reticle image is blurry and the image position will change when laser wavelength drifts. Therefore the system is impractical.

Another optical system of holographic sight is disclosed in the patent US2006/0164704 issued to Eric J. Sieczka et al. The system consists of a convex lens, a prism, a hologram and a grating. The system has relatively low height but has too long horizontal length. Moreover, the image position will vary with drifting laser wavelength.

A more complicated optical system is disclosed in U.S. Pat. No. 6,490,060 issued to Anthony M. Tai et al. The system consists of an LD, a reflector, an off-axis concave reflector, a holographic reflective grating and a hologram. The laser beam emitted by an LD is collimated by the concave reflector. The grating is used to filter the laser beam. This is a relatively successful system and has achieved practical application. However some elements in the optical system are difficult to fabricate and expensive. Moreover, since the diffraction angles of reflective gratings are sensitive to temperature and moisture, the change of image position can hardly be completely eliminated.

It is thus desirable to design an optical system that can generate a parallex-free holographic virtual image, can completely avoid image displacement caused by wavelength drift, and is compact both in height and length.

### FIELD OF INVENTION

The invention relates to an optical system containing a holographic optical element (HOE) for a holographic sight. The holographic sight with the invented optical system can be used for various small arms.

### SUMMARY OF THE INVENTION

It is therefore an object of the present invention to provide a compact and inexpensive optical system for a holographic sight used for different kinds of small arms.

It is yet another object of the present invention to provide an optical system for a holographic sight that an HOE is used to collimate, filter and deflect a laser beam so as to make the system more compact.

It is yet another object of the present invention to provide an optical system for a holographic sight that the displacement of the holographic reticle image generated by a hologram is completely avoided when laser wavelength drifts so that accurate aiming can be guaranteed. The objective is realized via the diffraction match of the HOE and the hologram.

In carrying out the above objectives, the optical system of the present invention includes an LD, two mirrors, a transmission HOE and a transmission hologram. LD provides a visible laser beam as the light source. The two mirrors direct the diverging laser beam through a distance to make the beam reaching required cross sectional area and falling onto the HOE in normal direction. The HOE diffracts the beam with the functions of collimation, filtering and deflection. The diffracted beam from HOE is incident onto the hologram with relatively large angle. The hologram projects a virtual holographic reticle image in normal direction of the hologram on target plane. Since the HOE and the hologram are in good diffraction match, the position of the reticle image will not change with drifting wavelength.

In order to acquire good diffraction match of HOE and hologram, the two elements must be positioned parallel and have the same fringe period.

The optical system includes:

A laser diode (LD) The LD is used to emit visible laser beam as the light source of the system.

Two mirrors The mirrors are used to control the path of the laser beam in order to realize a compact system and make the beam reaching required cross sectional area.

A holographic optical element (HOE) The HOE is a transmission diffractive optical element, mounted vertically in the system. When the divergent laser beam is falling on the surface of HOE, at the back of HOE a filtered and collimated beam is generated and incident onto the hologram with a relatively large angle. The HOE can be obtained by recording the interference pattern formed by the interference of a coaxial spherical wave and an off-axial collimated wave in a holographic material, or generated with computer.

A hologram The hologram is a transmission type hologram, vertically mounted and parallel with HOE. Everywhere of the hologram is recorded with the information of a holographic reticle image. When the collimated laser beam from the HOE strikes the hologram with certain incident angle, through the hologram the shooter can see a reticle image in normal direction of the hologram. If the hologram is broken or contaminated, as long as a small part of the hologram is maintained, the same reticle image can still be seen. The reticle image can be the pattern of a cross, circle, dot, etc. The method for fabricating the hologram can be learned from various holographic technical books and optical textbooks.

### BRIEF DESCRIPTION OF THE DRAWINGS

FIG. 1 is a schematic diagram of the optical system of the present invention.

FIG. 2 is a schematic side view of a holographic sight adopting the optical system of the present invention.

### DETAILED DESCRIPTION OF THE INVENTION

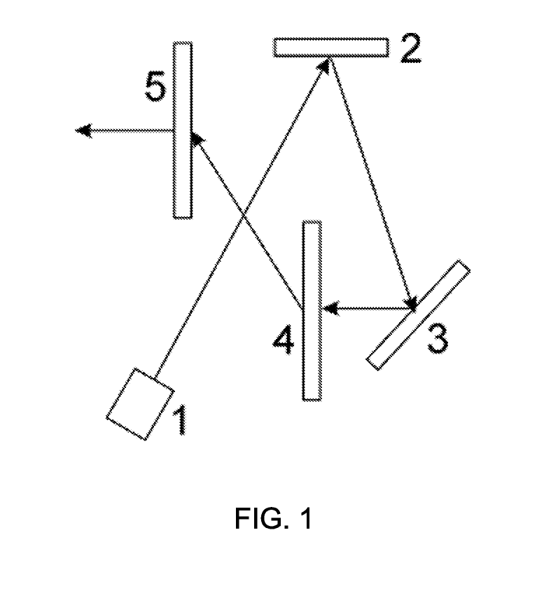

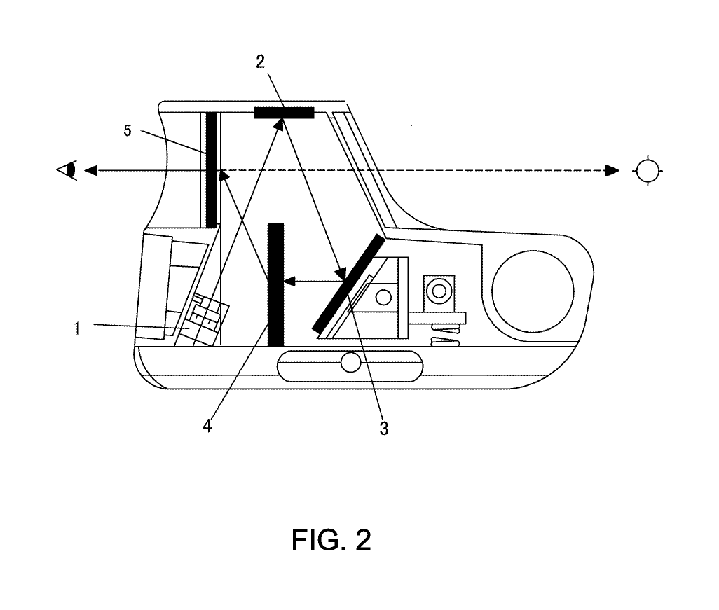

The optical system of the present invention is shown in FIG. 1. The LD (1) emits a visible laser beam travelling upwards. The beam hits a mirror (2) mounted on the top of the system, then is reflected and travels downwards to the second mirror (3). The beam reflected by the second mirror (3) strikes the HOE, which is mounted vertically, with normal incidence. The distance from LD to HOE equals or approximately equals the focal length of HOE. The diffraction of HOE has three functions: 1. causing beam dispersion to filter unwanted wavelengths; 2. as a lens to collimate the divergent laser beam; 3. deflecting the beam to make the beam incident onto the hologram with required angle. After HOE, the collimated beam illuminates the hologram with a relatively large incident angle. The hologram, which is also mounted vertically, projects a virtual reticle image in normal direction to target plane. The reticle image is clear and parallax free so that accurate aiming can be guaranteed. HOE and hologram are in parallel and have the same fringe period to obtain good diffraction match, the image shift caused by wavelength drift thereby is avoided. FIG. 2 shows a sample of the holographic sight installed with the optical system of the present invention with an LD (1′), the first mirror (2′), the second mirror (3′), an HOE (4′) and a hologram (5′).

Compared with other related optical systems disclosed in some patents, there are two advantages in the present invention: 1. HOE and hologram have good diffraction match so that the change of image position due to wavelength drift is completely eliminated; 2. HOE has multiple functions so that concave mirror, convex lens, and reflective grating are not needed in the system, which results in a more compact optical system with easily fabricated inexpensive optical elements.

What is claimed is:

1. An optical system for a holographic sight, including
a laser diode (LD) emitting visible laser beam as the light source of the system,
two mirrors mounted in the path of the beam to direct the laser beam from the LD through certain distance. One mirror reflects the upward beam from the LD downwards, and the second mirror reflects the downward beam to horizontal,
a holographic optical element (HOE) mounted in the path of the laser beam with the element plane perpendicular to the incident beam from the second mirror, to filter and collimate the beam and make the beam propagating upwards with relatively large angle,
a hologram mounted in the path of the collimated laser beam from HOE with relatively large incident angle to generate a virtual reticle image to the target plane in normal direction.

2. The optical system of claim 1 wherein the HOE and the hologram are parallel and have the same fringe period so as to achieve good diffraction match.

3. The optical system of claim 1 wherein the distance between LD and HOE equals or approximately equals the focal length of HOE.

4. An optical system for a holographic sight, including an LD, a transmission HOE and a transmission hologram. The said transmission HOE and said transmission hologram are mounted in parallel. The LD emits visible laser beam as the light source. The divergent laser beam falls on HOE in normal direction with certain cross sectional area. HOE diffracts the laser beam with the functions of collimation, filtering and deflection and makes the beam falling onto the hologram with certain angle. The hologram projects a holographic reticle image in normal direction to target plane.

5. The optical system of claim 4 wherein the HOE and the hologram are parallel and have the same fringe period so as to achieve good diffraction match.

6. The optical system of claim 4 wherein the path of laser beam is controlled by two mirrors. LD provides visible laser beam as the light source. The said mirrors direct the laser beam passing a distance to reach certain cross sectional area then incident onto HOE in normal direction.
